(19) United States
(12) Patent Application Publication
(10) Pub. No.: US 2005/0175432 A1
(43) Pub. Date: Aug. 11, 2005

(54) Screw

(76) Inventor: Kuo-Tai Su, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/773,399

(22) Filed: Feb. 9, 2004

(51) Int. Cl. F16B 35/04

(52) U.S. Cl. 411/417

(57) ABSTRACT

A screw including a head, a shank under the head in a whole body, and a thread helically built upon the outside trunk of the shank. The thread projects from the circular trunk of the shank and consists of an upper flank, a low flank, and an edge on the joint line of the upper and low flanks, and an even number of axial slots formed on the thread. Every axial slot is beveled with a back angle to form a tilt surface from the upper flank to the low flank to form a cutting edge for facilitating the rapid fastening with a smaller tapping torque.

### BACKGROUND OF THE INVENTION

1. Field of the Invention

This invention relates to a screw, more particularly to a rapid tapping screw with less torque.

2. Description of the Related Art

In accordance with the conventional screw, as shown in FIG. 1, it includes a head 11 and a shank 12 connecting with the head 11; wherein, there are several helical threads 13 built upon the surface of said shank 12.

When the conventional screw 1 is screwed in a wooden object 2, along with the shank 12 screwing in, by means of the shearing action of the threads 13, it is fastened in there. However, due to the facts that the threads 13 cannot cut through the wooden fabric, the wooden fabric chips produced could not be removed out rapidly, and so on, the tapping resistance is increased. Hence, the worker has to apply bigger tapping force on it in order to implant the screw 1 into the object 2, even if the greater tapping torque applied occurs the screw 1 overloading to be broken up. Therefore, the conventional screw 1 should be improved in design.

For this sake, there are some manufactures innovating the conventional screw 1. An innovated screw 3, as shown in FIG. 2, is came out, which is comprised of a head 31 and a shank 32 connecting with said head 31, and a thread 33 helically built upon the shank 32, wherein on the thread 33 there is even number of axial slots 331 formed.

Referring to FIG. 3, when fasten the screw 3, take the advantages of the axial slots 331 of said thread 33 to increase the containing space of the wooden fabric chips. Meanwhile, cooperating to the cutting process of said thread 33, the side edges of the axial slots 331 is designed to work as cutting rims for getting rapid tapping with less force goal.

However, in practice, there are some shortcomings existing in the screw 3 as followings:

1. Not Getting Desired Fastening Effect:

When tap into the object 4, due to that the small tooth height of the thread 33 projected up from the shank 32, the cutting effect could not get desired level in cutting and holding chips even though the thread 33 is cut cross with the axial slots 331. Therefore, the actual practice effect of the screw 3 has not been improved obviously comparing with the conventional screw 1.

2. Tapping Resistance Still Big:

As previously discussed, cutting said axial slots 331 naturally form a vertical side 332 crossing the thread 33. Therefore, when tap the thread 33 in, the vertical side 332 directly strikes and cuts the flexible object 4. Thus the elastic wooden fabric cannot be cut through immediately. On the contrary, the wooden fabric twins on the axial slot 332 and the shank 32, further to increase the tapping resistance of the screw 3.

### SUMMARY OF THE INVENTION

It is, therefore, a main object of the present invention to provide a rapid tapping screw with lower tapping torque.

For archiving the object, the present invention provides a screw comprising of a head, a shank and a thread helically built on the shank; wherein, on the thread there is even number of axial slots formed. Meanwhile, every axial slot is beveled with a back angle to form a sheared section from the upper flight to the low flight to form a cutting edge. As tapping the screw, the cutting lips will improve the cutting speed to get rapid fastening with less tapping torque goal.

### BRIEF DESCRIPTION OF THE DRAWINGS

The accompanying drawing is to provide a further understanding of the invention and to incorporate in and constitute a part of this specification. The drawing illustrates an embodiment of the invention, and together with the description, serves to explain the principles of the invention. In the drawing,

FIG. 1 is a sectional view of the prior art.

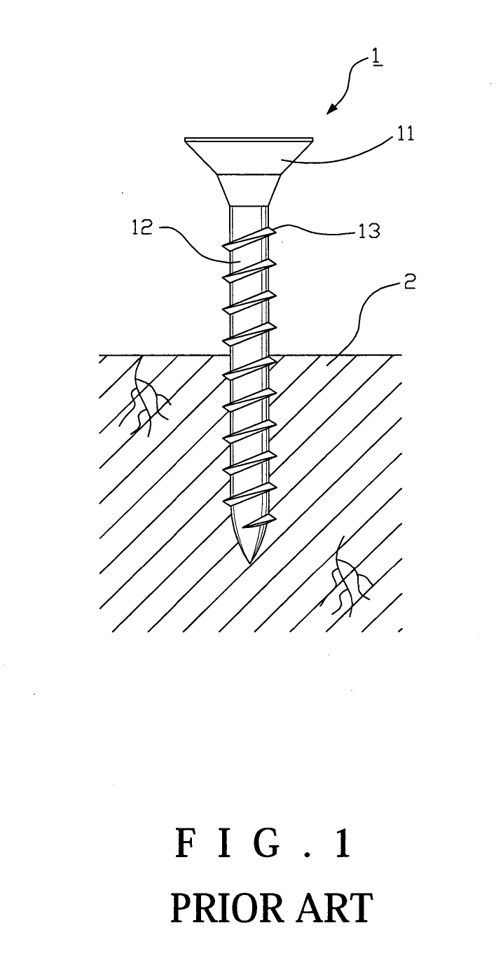

FIG. 2 is a schematic view of the second prior art.

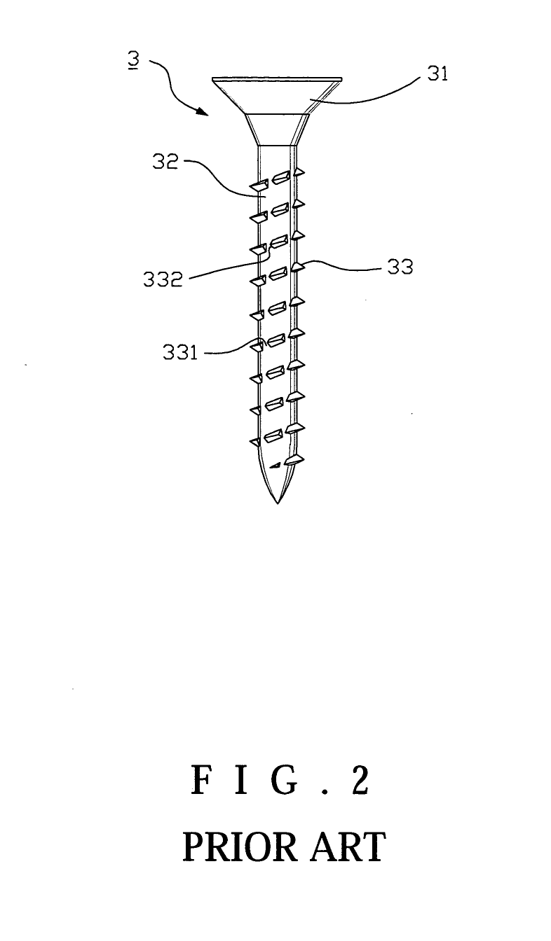

FIG. 3 is a cross-section view showing the implanted stated of the second prior art.

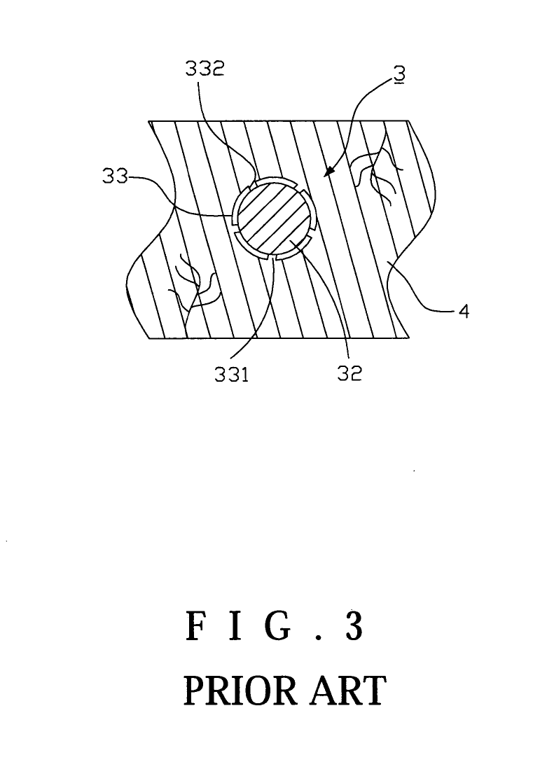

FIG. 4 is a schematic view of the present invention.

FIG. 5 is a enlarged view of FIG. 4A part showing the thread of the present invention.

FIG. 6 is a cross-section view showing the implanted stated of the present invention.

### DETAILED DESCRIPTION OF THE PREFERRED EMBODIMENTS

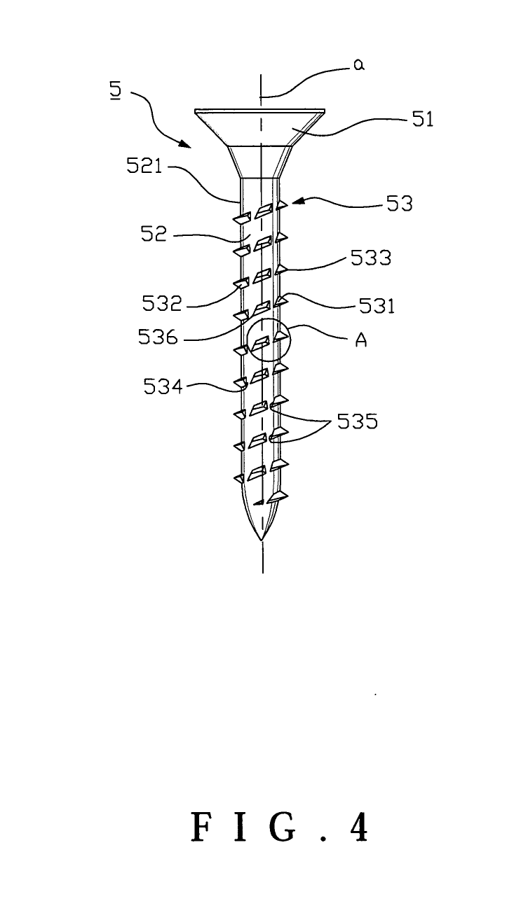

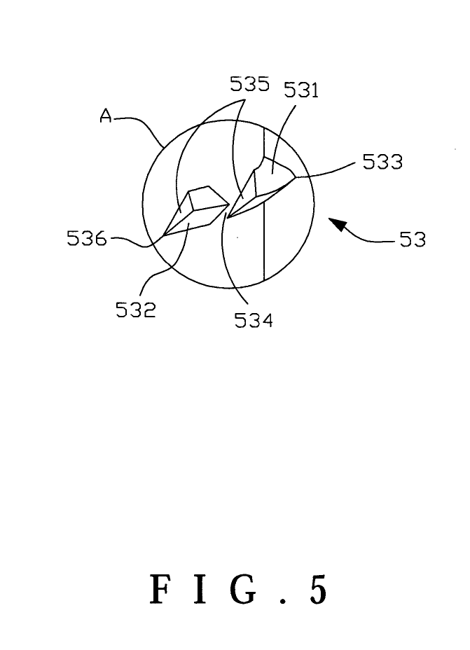

Referring to FIG. 4 and FIG. 5, the first embodiment of the present invention provides a screw 5 consisted of a head 51, a shank 52 under the head 51 in a whole body, and a thread 53 helically built upon the outside trunk of the shank 52. Wherein, said shank 52 has a base circle surface 521 surrounding the axis. The helical thread 53 projects from the base circle surface 521. Said thread 53 is consisted of an upper flight 531, a low flight 532, and a peak 533 on the joint line of the upper and low flights 532 533, and an even number of axial slots 534 formed on the thread 53 of the shank 52 in equidistance. The feature is that every axial slot 534 is beveled with a back angle to form a sheared section 535 from the upper flight 531 to the low flight 532, so as to form a cutting edge 536.

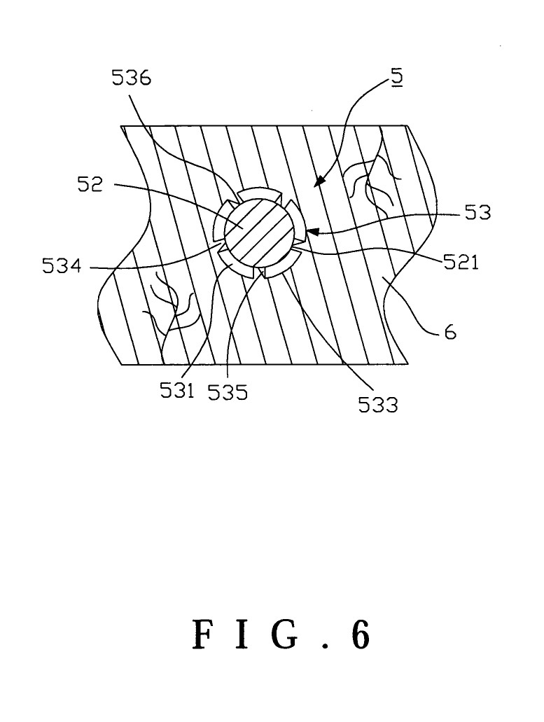

Referring to FIG. 5 and FIG. 6, when secure the screw 5 on an object 6, the worker should vertically press the screw 5 on the surface of the object 6 with the bottom end, and continuously exert tapping forcing on the head 51 of the screw 5. Hence the thread 53 is turned simultaneously, in order to tap into the object 6. Along with the implanting of the thread 53, the peak 533 of the thread 53 can cut the object 6, and the cutting lips 536 consisted of the sheared section 535 and the low flights 532 can also cut simultaneously as a hatchet. So that, as screwing the thread 53, the cutting lips 536 can circularly cut for rapidly and efficiently shear the interlace and twined wooden fabric, further to reduce the tapping resistance to get rapid fastening effect and to reduce the tapping torque. It is for sure that the uncut wooden fabric by the cutting lips 536 can be led by the sheared section 535 to the rear cutting edge for cutting through.

In accordance with above description, the improvement of the present invention based on the prior art can be obviously found as following:

1. Better fastening effect: when screw into the object 6 with the screw 5, due to the sheared section 535 at the side of the axial slot 534 beveled on the thread 53, the size of the axial slot 534 is expended to increase the space of containing chips for facilitating to cut fluently.

2. Rapid fastening with smaller tapping torque: as above description, the sheared section 535 beveled on the thread 53 at the side of the axial slot 534 cooperates to the low flight 532 to form a cutting lip 536 as sharp as a hatchet. Thus, as fastening the thread 53, not only take the original peak 533 to cut, but also the cutting lip 536 is to shear the wooden fabric firstly to efficiently cut through the interlace and twined wooden fabric. It is sure that the uncut wooden fabric by the cutting lips 536 can be led by the sheared section 535 to the rear cutting edge for cutting through. Therefore it is helpful to reduce command of tapping torque as screwing the screw 5 for preventing the screw 5 from breaking up.

According to the above description, the main feature of the present invention is to bevel a sheared section on the thread at the side of the axial slot, and said sheared section cooperates with the low flight to form a cutting lip to help the thread do rapid cutting to screw in the object. Meanwhile, during the screw tapping in process, the chips produced can be also removed and contained immediately. To get rapid fastening with smaller tapping torque.

While the present invention has been described in connection with what is considered the most practical and preferred embodiments. It is understood that this invention is not limited to the disclosed embodiments but is intended to cover various arrangements included within the spirit and scope of the broadest interpretations and equivalent arrangements.

1. A screw comprises a head, a shank extending from the head, and a thread helically built upon an outside of the shank, wherein, said thread is consisted of an upper flank, a low flank, and an edge on the joint line of the upper and low flanks, an even number of axial slots are formed in the thread, each axial slot is beveled with a back angle to form a tilt surface relative to the upper flank and the low flank so as to form a cutting edge from which the tilt surface and the low flank extend.
